(19) United States
(12) Patent Application Publication
(10) Pub. No.: US 2003/0125153 A1
(43) Pub. Date: Jul. 3, 2003

(54) Low range mode for continuously variable transmission

(76) Inventors: Richard Kukucka, Ann Arbor, MI (US); Thomas A. Dailey, Walled Lake, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/036,301

(22) Filed: Dec. 27, 2001

(51) Int. Cl. F16H 37/08

(52) U.S. Cl. 475/198; 475/199

(57) ABSTRACT

A vehicle is provided with a continuously variable transmission having a low range operating mode for off road driving. A wide range continuously variable transmission is combined with a high fixed ratio final drive mechanism to provide a high gear ratio low range mode. A power take-off unit provides driving torque to a second pair of drive wheels and a coupling mechanism is provided in a second drive line for providing all wheel drive operation in response to wheel slip of the primary drive wheels.

### FIELD OF THE INVENTION

The present invention relates to a continuously variable transmission, and more particularly, to a low range operating mode for a continuously variable transmission having four-wheel drive and all-wheel drive operating capabilities.

### BACKGROUND AND SUMMARY OF THE INVENTION

Continuously variable transmissions (CVTs) have been under development for many years. The CVT allows almost unlimited ratio changes between engine and final drive. An advantage of a CVT is that it permits the engine to run at near-constant speed, within its most fuel efficient RPM range, regardless of load or driver demands. The belt drive CVT includes a primary pulley, a drive belt, and an output pulley. A hydraulic or electronic unit can control the working diameter of the two pulleys in order to adjust the drive ratio of the CVT. The continuous range of transmission ratio changes is effected by changing the belt position between the pulley sheaves. The pulleys each have a fixed cone and a movable cone in which, for example, a hydraulic cylinder is built. Actuation of the hydraulic cylinders causes the pulleys to move axially and change the space between the fixed and movable cones. This, in turn, creates a pinching action on the belt anywhere along the pulley grooves. Basically, the deeper the belt rides in the groove, the smaller the working diameter of the pulleys.

Other types of known CVTs include toroid-type CVTs. CVTs have been known to be used in motor scooters and commuter cars, and sub-compact vehicles, including small engines. Design problems of belt drive CVTs have arisen with respect to developing belts that are suitable for use in larger vehicles since larger levels of torque are typically required to be delivered by the transmission. Applications such as sport utility vehicles which are intended to be used for off-road driving have, therefore, not lent themselves to applications using continuously variable transmissions. However, there is a recent trend toward creating smaller sport utility-type vehicles that require less torque, but for which a low range operating mode (lower than typically required for standard continuously variable transmissions) as well as all-wheel drive and four-wheel drive applications are desirable.

Four-wheel drive systems permit a vehicle to be driven by all four wheels with torque distribution locked to both axles. The principle advantages of four-wheel drive are better traction and greater control of the vehicle in adverse conditions such as muddy roads, wet, snow, or ice covered roads, loose surfaces, or hazardous off-road terrain. Typically, for off-road driving, a low range operating mode is also desirable since off-road driving can involve climbing hills and traversing valleys that require slow speeds and high torque in order to maintain control during off-road driving. All-wheel drive systems automatically react to normal or adverse situations without the need for the driver to decide when or when not to shift into a four-wheel drive operating mode. In all-wheel drive applications, the shifting is automatic. When wheel slip is detected at a pair of primary drive wheels, the system automatically delivers torque to a secondary set of drive wheels.

U.S. Pat. No. 6,093,125 discloses an all-wheel drive continuously variable transmission that utilizes a conventional gear set (transfer case) to deliver a low range operating mode. However, this low speed gear set adds additional undesirable weight and cost to the vehicle transmission system and typically requires stopping the vehicle for change into low range. Accordingly, it is desirable to provide a continuously variable transmission for use with an all-wheel drive or four-wheel drive vehicle for off-road purposes having a low range operating mode without the requirement of an additional low-speed mode gear set.

Accordingly, the present invention provides a vehicle powertrain including a continuously variable transmission. The continuously variable transmission can be a belt-type or toroid-type CVT system. The continuously variable transmission is drivingly connected to the engine and the continuously variable transmission has an effective low range gear ratio of at least 15. A power take-off unit is provided for delivering torque to a second pair of drive wheels through a second driveline. A coupling mechanism is provided in the second driveline for delivering torque to the second pair of drive wheels in response to slip of the first pair of drive wheels. A user interface switch is provided for actuation by the driver for engaging the continuously variable transmission in the low range operating mode and can be optionally provided with the capability to lockingly engage the coupling mechanism in the second driveline for providing a four-wheel drive operating mode.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a vehicle with a continuously variable transmission having an integral low range operating mode and all wheel drive and four wheel drive capabilities according to the principles of the present invention; and

FIG. 2 is a schematic illustration of the powertrain system of FIG. 1 showing greater detail of the components thereof.

### DETAILED DESCRIPTION OF THE PREFERRED EMBODIMENTS

The following description of the preferred embodiment(s) is merely exemplary in nature and is in no way intended to limit the invention, its application, or uses.

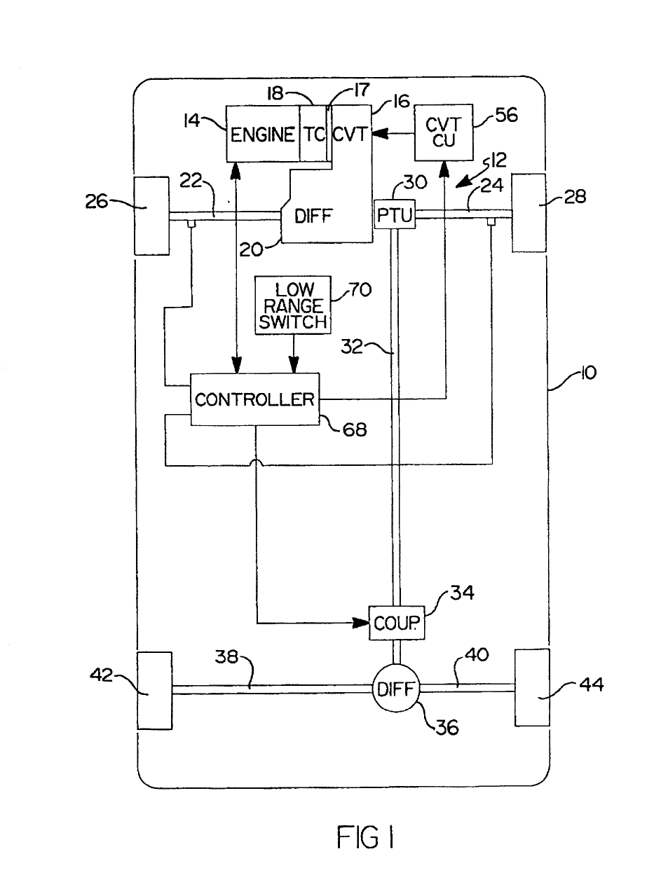

With reference to FIG. 1, a vehicle 10 is shown including a powertrain 12 having an engine 14 and a continuously variable transmission (CVT) 16. A torque converter, or other friction coupling-type mechanism 18, is provided for delivering engine torque to the continuously variable transmission 16 through a reversing planetary gearset 17, as is known in the art. The continuously variable transmission 16 delivers torque to a first differential 20 which provides driving torque through a pair of axle shafts 22, 24 to a primary pair of drive wheels 26, 28, respectively. A power take-off unit 30 is provided on the axle shaft 24 for driving axle 32 for providing a second driveline. A coupling mechanism 34 is provided on the drive axle 32 and when engaged, delivers drive torque to a second differential 36. The second differential 36 distributes drive torque to a pair of axle shafts 38, 40 which are connected to secondary drive wheels 42, 44, respectively.

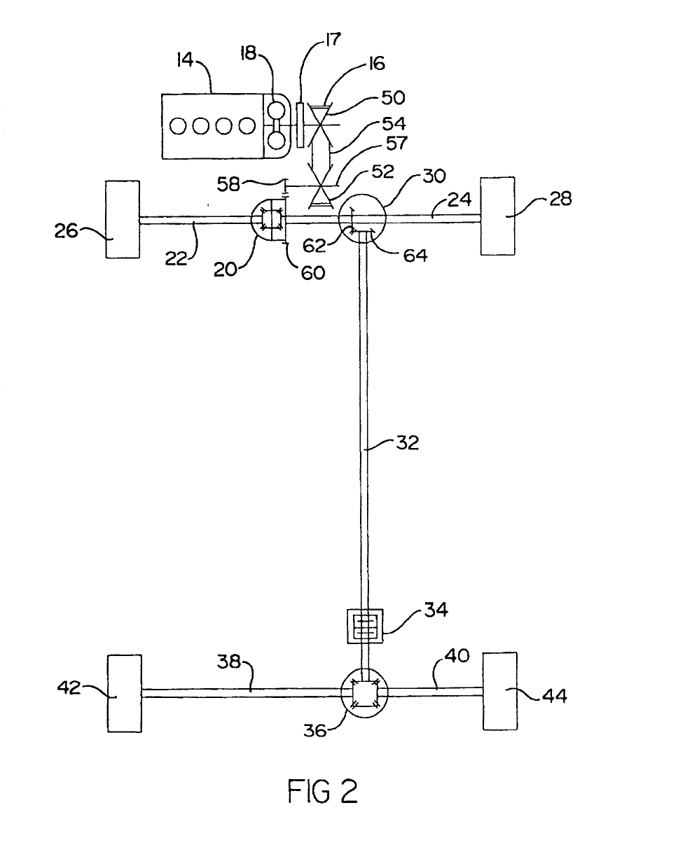

The continuously variable transmission 16, as best shown in FIG. 2, includes a drive pulley 50 and a driven pulley 52 drivingly connected to one another by a belt 54. As is known in the art, the drive pulley 50 and driven pulley 52 are provided with adjustable sheaves for varying the drive ratio of the continuously variable transmission 16. The sheaves of the continuously variable transmission 16 can be hydraulically or electronically controlled by a CVT control unit 56 (as shown in FIG. 1). The driven pulley 52 is mounted for rotation with an intermediate shaft 57 having a drive gear 58 which drives an input gear 60 of the front differential 20. The differential 20 includes a fixed speed reduction.

The continuously variable transmission preferably has a drive ratio which ranges from 0.4 to approximately 3. The fixed final drive ratio between gear 58 and input gear 60 of the differential 20 should be greater than 5 and preferably about 7.5. In comparison, conventional final drive gear ratios are typically on the order of 3-4. For purposes of the present example, the fixed final drive ratio of the drive gear 58 and input gear 60 is 7.5 and the continuously variable transmission and final drive ratio provide an effective gear ratio range from approximately 3 to approximately 22. Thus, the transmission has an effective low range gear ratio of approximately 22.

Conventional continuously variable transmission systems have an effective gear ratio range from about 2 to about 13. However, with the larger fixed final drive ratio gear mechanism of the present invention, a greater effective range of approximately 3 (7.5 fixed final drive ratio×0.4 CVT high ratio) to about 22 (7.5 fixed final drive ratio×3.0 CVT low range ratio), is provided. Other known CVT applications provided in four-wheel or all-wheel drive applications have required a two-speed transfer case in order to provide a low range operating mode above 15 while the present invention provides a low range operating mode with a gear ratio of approximately 22 without the requirement of a two-speed transfer case as required by the prior art systems.

The power take-off unit 30 is provided with a bevel or helical gear 62 driven by the axle shaft 24. A driven gear 64 is connected to the drive axle 32 and engages gear 62. In this configuration, drive axle 32 is continuously driven by the axle shaft 24. The coupling mechanism 34 can be of the known viscous coupling, gerotor pump coupling, and electromagnetically controlled coupling type devices. Each type of coupling mechanism is responsive to a slip of the primary driven wheels for engaging the coupling mechanism for delivery of drive torque from the drive axle 32 to the rear differential 36 for driving the rear wheels 42, 44.

A vehicle control module 68 is provided for controlling the operation of the engine 14 and continuously variable transmission 16. As is known in the art, the controller 68 receives signals representative of the engine speed, accelerator pedal position, vehicle speed, transmission gear ratio, etc. The controller 68 provides signals to the CVT control unit 56 which can be an electronic or hydraulic control unit for either providing electric signals or hydraulic fluid for changing the drive ratio of the continuously variable transmission 16, as is known in the art.

A user interface mechanism, such as a low range switch 70 is provided for providing signals to the controller 68 indicative of a driver's desire to shift into a low range operating mode for off-road driving. Upon actuation of the low range switch 70, the controller 68 determines whether the vehicle is traveling at an acceptable speed for shifting the continuously variable transmission 16 into the low range operating mode. In order to prevent engine overrun, the controller 68 does not allow a shift to the low range operating mode when the vehicle is above a predetermined speed such as, for example, 25 mph. An advantage of the use of a continuously variable transmission is that the continuously variable transmission 16 can be switched to the low range operating mode at speeds up to approximately 25 mph as compared to conventional transmissions utilizing transfer cases that can only be shifted to a low range operating mode when the vehicle is either at rest or going at a very slow rate of speed.

Simultaneous with changing the continuously variable transmission 16 to a low range operating mode, the controller 68 also engages the coupling mechanism 34 such as by an electronic signal to an electromagnetically controlled coupling for engaging the secondary drive wheels 42, 44 in a full time four-wheel drive operating mode while the CVT 16 is in its low range operating mode.

The system of the present invention exploits a wider ratio spread of a continuously variable transmission by providing a high final drive ratio to reach an overall top gear ratio roughly similar to a distinct ratio automatic transaxle/transmission in overdrive. A driver interface allows an overall low range gear ratio for off-road purposes with a gear ratio greater than a conventional automatic transaxle/transmission in first gear. In particular, a low range gear ratio greater than 15 can be obtained utilizing the present invention without the requirement of a two-speed transfer case as is required in many prior art devices. Thus, an all-wheel drive vehicle is provided which delivers a low range four-wheel drive mode without a transfer case while providing the efficiency benefits of a continuously variable transmission.

The present invention allows cost savings, weight reduction, and package space reduction as compared to current systems which utilize transfer cases for achieving a low range operation mode in a four-wheel drive vehicle. The present invention also enables a four-wheel drive transverse powertrain to deliver a low range. Continuously variable transmissions currently tend to be more expensive than conventional automatic transmissions. However, the present invention has the capability of achieving a low range operating mode without a transfer case and therefore, offsets the current cost penalty of CVTs as compared to conventional automatic transmissions provided with a transfer case.

The description of the invention is merely exemplary in nature and, thus, variations that do not depart from the gist of the invention are intended to be within the scope of the invention. Such variations are not to be regarded as a departure from the spirit and scope of the invention. For example, the present invention has been described in detail using a belt drive CVT, although it should be understood that other known CVTs, such as a toroidal-type CVT, may also be utilized with the present invention.

What is claimed is:

1. A vehicle powertrain, comprising:
a continuously variable transmission; and
a fixed ratio drive gear mechanism with gear reduction connected to said continuously variable transmission, wherein said continuously variable transmission with the fixed ratio drive gear mechanism has an effective low range gear ratio of at least 15.

2. The powertrain according to claim 1, wherein said continuously variable transmission with the fixed ratio drive gear mechanism has a low range gear ratio of at least 20.

3. The powertrain according to claim 1, further comprising a first differential for distributing torque from said fixed ratio drive gear mechanism to a first pair of drive wheels through a first driveline.

4. The powertrain according to claim 3, further comprising a second differential for distributing torque from said fixed ratio drive gear mechanism to a second pair of drive wheels through a second driveline.

5. The powertrain according to claim 4, further comprising a coupling mechanism disposed in said second drive line for providing drive torque to said second pair of drive wheels.

6. The powertrain according to claim 5, wherein said coupling mechanism is a viscous coupling.

7. The powertrain according to claim 5, wherein said coupling mechanism is a gerotor pump type-coupling.

8. The powertrain according to claim 5, wherein said coupling mechanism is an electromagnetically controlled coupling.

9. The powertrain according to claim 1, further comprising a controller unit and a driver interface mechanism for selectively shifting said continuously variable transmission to a low range operating mode in response to actuation of said driver interface mechanism.

10. The powertrain according to claim 5, further comprising a controller unit and a driver interface mechanism for selectively shifting said continuously variable transmission to a low range operating mode in response to actuation of said driver interface mechanism, said controller unit and driver interface mechanism also selectively engaging said coupling mechanism in response to actuation of said driver interface mechanism for engaging a four wheel drive operating mode.

11. The powertrain according to claim 5, further comprising a controller unit and a driver interface mechanism for selectively engaging said coupling mechanism in response to actuation of said driver interface mechanism for engaging a four wheel drive operating mode.

12. The powertrain according to claim 4, further comprising a power take-off unit in said second driveline.

13. A vehicle, comprising:
an engine;
a continuously variable transmission having a drive pulley and a driven pulley drivingly connected by a belt, said drive pulley drivingly connected to said engine, said continuously variable transmission further including a fixed ratio drive gear mechanism connected to said driven pulley, said fixed ratio drive gear mechanism having a gear ratio of at least 5;
a first differential connected to a first pair of drive wheels and drivingly connected to said fixed ratio drive gear mechanism through a first drive line;
a second differential connected to a second pair of drive wheels and drivingly connected to said fixed ratio drive gear mechanism through a second drive line; and
a coupling mechanism in said second drive line for delivering torque to said second pair of drive wheels in response to slip of said first pair of drive wheels.

14. The vehicle according to claim 13, wherein said fixed ratio drive gear mechanism has a gear ratio of at least 7 and said continuously variable transmission has an effective low range gear ratio of at least 20.

15. The vehicle according to claim 13, wherein said coupling mechanism is a viscous coupling.

16. The vehicle according to claim 13, wherein said coupling mechanism is a gerotor pump type-coupling.

17. The vehicle according to claim 13, wherein said coupling mechanism is an electromagnetically controlled coupling.

18. The vehicle according to claim 13, further comprising a driver interface mechanism for selectively shifting said continuously variable transmission to a low range operating mode in response to actuation of said driver interface mechanism.

19. The vehicle according to claim 13, further comprising a driver interface mechanism for selectively shifting said continuously variable transmission to a low range operating mode in response to actuation of said driver interface mechanism, said driver interface mechanism also selectively engaging said coupling mechanism in response to actuation of said driver interface mechanism.

20. The vehicle according to claim 13, further comprising a driver mechanism for selectively engaging said coupling mechanism in response to actuation of said driver interface mechanism for engaging a four wheel drive operating mode.
